(19) United States
(12) Patent Application Publication
(10) Pub. No.: US 2008/0237538 A1
(43) Pub. Date: Oct. 2, 2008

(54) Process for Preparing Lithium Amide and a Composition Obtainable by Said Process

(75) Inventors: Ian V.J. Archer, Edinburgh (GB); Noel A. Hamill, Huddersfield (GB)

Correspondence Address: FOLEY HOAG, LLP;PATENT GROUP, WORLD TRADE CENTER WEST, 155 SEAPORT BLVD, BOSTON, MA, 02110, US

(73) Assignee: Aveica Pharmaceuticals Limited, Manchester (GB)

(21) Appl. No.: 10/590,167

(22) PCT Filed: Feb. 14, 2005
(86) PCT No.: PCT/GB05/00480

§ 371 Date: Jul. 2, 2007

(30) Foreign Application Priority Data
Feb. 19, 2004 (GB) 0403696.8

(51) Int. Cl. C01B 21/092; C09K 3/00

(52) U.S. Cl. 252/182.34; 423/413

(57) ABSTRACT

There is provided a process for preparing a lithium amide composition in which in a first step lithium metal is brought into contact with ammonia to form lithium bronze and in a second step the lithium bronze is reacted with a 1,3-diene or an arylolefin, such as butadiene, isoprene, piperylene, dimethylbutadiene, hexadiene, styrene, methyl styrene, divinylbenzene, naphthalene or anthracene, in the presence of a solvent wherein the temperature is maintained at or below the boiling point of ammonia. Examples of solvents include pentane, cyclopentane, hexane, heptane, octane, cyclohexane, toluene, xylene, cumene, ethyl benzene, tetraline, diethyl ether, tetrahydrofuran (THF), 2-methyl-THF, tetrahydropyran, diisopropyl ether, dibutyl ether, dioxan, methyl-tert-butyl ether or glycol ether. Lithium amide compositions obtainable by said process show improved activity, particularly in reactions involving enolate formation.

The invention relates to a process for preparing lithium amide and to a composition obtainable by said process.

Lithium amide is a strong inorganic base that finds use as a reagent in synthetic organic chemistry (Encyclopaedia of Reagents for Organic Synthesis, Vol. 5, 3031, L. A. Paquette, John Wiley 1995).

Various methods are known for the preparation of lithium amide. One known process involves the reaction of lithium metal and gaseous ammonia at high temperatures, often around 400° C.

Low temperature processes whereby lithium metal is dissolved in liquid ammonia and subsequently reacted under the catalysis of a transition metal compound are also known (for example the use of Cobalt is described in U.S. Pat. No. 4,206,191, and the use of iron III nitrate is described in Gmelin, Lithium, Supplementary Volume 20, 279).

U.S. Pat. No. 5,486,343 describes a method for preparing lithium amide in which lithium metal is dissolved in ammonia in the presence of solvent to form lithium bronze and subsequently the lithium bronze is thermally decomposed to form lithium amide, hydrogen and ammonia.

Each of these methods suffers from the disadvantage that large quantities of hydrogen are produced as a by-product of the reaction.

In EP1238944, a process is described wherein hydrogen production is suppressed by the presence of a diene or an arylolefin. However, in our hands, it has been found that lithium amide produced according to the method described in EP1238944 lacks activity particularly when used in reactions involving the production and reaction of enolates by deprotonation of certain esters of carboxylic acids.

The object of the invention is to overcome the disadvantages of the prior art and in particular to provide a method for preparing active lithium amide while ameliorating the production of gaseous hydrogen.

Accordingly, there is provided a process for preparing a lithium amide composition in which in a first step lithium metal is brought into contact with ammonia to form lithium bronze and in a second step the lithium bronze is reacted with a 1,3-diene or an arylolefin in the presence of a solvent wherein the temperature is maintained at or below the boiling point of ammonia.

In the first step where the lithium metal is brought into contact with ammonia, this may be achieved by charging the lithium metal to the ammonia. More preferably, the lithium metal is brought into contact with ammonia by charging the ammonia to the lithium metal.

Preferred 1,3-dienes or arylolefins are butadiene, isoprene, piperylene, dimethylbutadiene, hexadiene, styrene, methyl styrene, divinylbenzene, naphthalene or anthracene.

The first reaction step may be carried out solvent free. However, operations are preferably carried out in a solvent in the first reaction step as well. Preferable solvents include acyclic or cyclic aliphatic hydrocarbons, aromatic hydrocarbons, ethers or mixtures thereof. Examples of suitable solvents include pentane, cyclopentane, hexane, heptane, octane, cyclohexane, toluene, xylene, cumene, ethyl benzene, tetraline, diethyl ether, tetrahydrofuran (THF), 2-methyl-THF, tetrahydropyran, diisopropyl ether, dibutyl ether, dioxan, methyl-tert-butyl ether or glycol ether.

The size and physical form of the lithium metal used in the reaction may be varied widely. Lithium may be used as a powder obtained from dispersion processes, as granules sometimes referred to as sand or shot depending on size, or as bulk metal, meaning pieces of any of the commercially available forms of lithium.

Anhydrous ammonia is used in amounts of 1 to 10, or more, equivalents per mole equivalent of lithium metal. One to six equivalents of ammonia are preferred, four to five equivalents are most preferred. While ten or more equivalents of ammonia can be employed this does not seem to have a great benefit on conversion and assay and results in a lot of excess ammonia to be recovered and recycled.

The method of introducing the ammonia is not critical. The ammonia can be introduced into the reactor above or below the surface of the solvent-lithium phase. Introducing the ammonia below the surface of the solvent-lithium phase provides useful agitation of the reaction mixture.

Preferably during both reaction steps lies, the temperature is maintained between −33 and −78° C., and more preferably between −35 and −65° C. Most preferably, the temperature is maintained at −40° C.

The heat of reaction in the first reaction step can be controlled, for example, by adjusting the rate at which the ammonia is added to the lithium.

When a solvent is used in the first reaction step, the lithium bronze that is formed by the reaction of the lithium and ammonia floats on the solvent and can optionally be separated for purification purposes.

The heat of reaction in the second reaction step can be controlled, for example, by adjusting the rate at which the 1,3 diene or arylolefin is charged to the lithium bronze. The lithium amide that is formed is insoluble and heavier than the reaction solution. The by-product formed by hydrogenation of the 1,3 diene or arylolefin is typically soluble in the reaction solvent.

Typically, 0.5 equivalents of 1,3-diene or arylolefin per mole equivalent of lithium are used. However, for certain arylolefins having multiple olefinic bonds, for example divinylbenzene, 0.25 equivalent of the arylolefin is typically required.

Excess ammonia may optionally be discharged in gaseous form, often the excess ammonia is recycled or reclaimed. Discharge of excess ammonia preferably is carried out between −33 and −78° C. by distillation at reduced pressure.

The lithium amide composition is typically isolated as a solvent slurry. Advantageously, the lithium amide composition obtainable by the process according to the first aspect of the present invention shows improved activity and may be used directly in organic reactions. For example, the lithium amide composition obtainable by the process according to the first aspect of the present invention shows improved levels of activity when deprotonating t-butyl acetate. The activity of lithium amide compositions (from various sources) towards enolate formation can readily be compared by observing the amount of enolate self-condensation product formed when aliquots of t-butyl acetate have been treated with lithium amide.

The lithium amide composition obtainable by the process according to the first aspect of the present invention preferably comprises lithium amide, ammonia and optionally one or more solvents.

Ammonia in the lithium amide composition may be present as free ammonia, or may be in some way associated with the lithium amide, for example present as a complex.

Optional solvents include those solvents as described in the first aspect of the present invention, and also includes the by-products obtained by hydrogenation of the 1,3 diene or arylolefin.

Preferably, the lithium amide composition obtainable by the process of the first aspect of the present invention comprises a molar ratio of lithium amide:ammonia greater than 1:0.5 (LiNH₂:NH₃), more preferably comprises a lithium amide:ammonia molar ratio greater than 1:1 (LiNH₂:NH₃).

The invention is illustrated by the following examples.

### EXAMPLE 1

### Li Bronze Formation and Conversion to Lithamide (4% w/w Li in THF Using Styrene)

1. Purge reaction vessel (1 l jacketed vessel) with argon to remove air and to prevent condensation when cooling is applied.
2. Cool to −65° C.
3. Charge required THF (60.90 g) to vessel.
4. Flush the vessel and charging lines with argon in order to establish an inert atmosphere. (Note: Li bronze reacts with N₂—hence need argon)
5. Charge lithium (4.0 g) to vessel gradually over a couple of minutes.
6. Open valve for ammonia addition to vessel.
7. Condense ammonia required into vessel to complete lithium bronze formation (39 g). (Note: Formation of a bronze layer on the top surface of the reaction mixture. Significant exotherm. Temperature is not allowed to exceed-33° C.).
8. Once the ammonia addition is complete, stop feed of ammonia. (Temperature is maintained at −40° C.).
9. Charge 10% of styrene aliquot (3_{—}33 ml of 99% styrene) to the vessel via syringe pump @ 0.8 ml/min. (Note: An exotherm will indicate the formation of lithium amide; this is larger than that observed due to the condensation of the NH₃.)
10. If an exotherm is not detected, open the feed valve on the ammonia and condense further ammonia until lithium amide starts to form (i.e. exotherm detected, generally 1-2 g needed).
11. Once formation of lithium amide h as started, close the feed valve and main valve on the ammonia
12. Charge a further 30.00 ml 99% styrene to the vessel via syringe pump @ 0.8 ml/min (note: Formation of a grey suspension. A significant exotherm is expected, accompanied by a temperature rise. The addition rate is determined by heat transfer characteristics of vessel in order to maintain temp close to −40 C).

### EXAMPLE 2

### Li Bronze Formation and Conversion to Lithamide (1% w/w Li in Hexane Using Divinylbenzene)

1. Purge reaction vessel with argon to prevent condensation in 1 L jacketed vessel.
2. Cool to −65° C.
3. Charge required hexane (171.8 g) to vessel.
4. Flush the vessel and charging lines with argon in order to establish an inert atmosphere. (Note: Li bronze reacts with N₂—hence need argon)
5. Charge lithium (2.0 g) to vessel gradually over a couple of minutes.
6. Open valve for ammonia addition to vessel.
7. Condense ammonia required into vessel to complete lithium bronze formation (20 g). (Note: Formation of a bronze layer on the top surface of the reaction mixture. Significant exotherm. Temperature is not allowed to exceed −33° C.).
8. Once the ammonia addition is complete, stop feed of ammonia. (Temperature is maintained at −40° C.)
9. Charge 10% of divinylbenzene aliquot (1.27 ml of 80% divinylbenzene) to the vessel via syringe pump @ 0.4 ml/min. (Note: An exotherm will indicate the formation of lithium amide; this is larger than that observed due to the condensation of the NH₃. Divinylbenzene has two reactive bonds, therefore half as much needed relative to styrene).
10. If an exotherm is not detected, open the feed valve on the ammonia and condense further ammonia until lithium amide starts to form (i.e. exotherm detected, generally 1-2 g needed).
11. Once formation of lithium amide has started, close the feed valve and main valve on the ammonia
12. Charge a further 11.4 ml 80% divinylbenzene to the vessel via syringe pump @ 0.4 ml/min (note: Formation of a white suspension. A significant exotherm is expected, accompanied by a temperature rise. The addition rate is determined by heat transfer characteristics of vessel in order to maintain temp close to −40 C).

### COMPARATIVE EXAMPLE 1

### Li Bronze Formation and Conversion to Lithium Amide in Hexane Using Styrene (as Described in EP1238944)

1. Purge reaction vessel (1 l jacketed vessel) with argon to remove air and to prevent condensation when cooling is applied.
2. Ensure reaction vessel is held at 20° C.
3. Charge hexane (153.2 g) to vessel.
4. Flush the vessel and charging lines with argon in order to establish an inert atmosphere. (Note: Li bronze reacts with N₂—hence need argon)
5. Charge lithium (4.0 g, 0.576 mol) to vessel gradually over a couple of minutes.
6. Open valve for ammonia addition to vessel.
7. Bubble ammonia into vessel to complete lithium bronze formation over 3 hours (40 g, 2.35 mol, 4.07 eq). (Note: Formation of a bronze layer on the top surface of the reaction mixture. Significant exotherm).
8. Once the ammonia addition is complete, stop feed of ammonia.
9. Charge the styrene aliquot (33.3 ml of 99% styrene) to the vessel via syringe pump @ 0.28 ml/min. (Note: An exotherm will indicate the formation of lithium amide; this is larger than that observed due to the condensation of the NH₃. Formation of a grey suspension. A significant exotherm is expected, accompanied by a temperature rise.)

### Lithamide Activity Test—Self-Condensation of Alkyl Acetate Enolate

The formation of the enolate on addition of alkyl acetate to lithium amide is effectively complete within the mixing time. Small amounts of unreacted alkyl acetate will catalyse the self-addition as the resulting product is more acidic than the initial enolate (see scheme). Consequently, the ratio of self-addition product to free TBA on warming to ambient is indicative of the activity of the enolate.

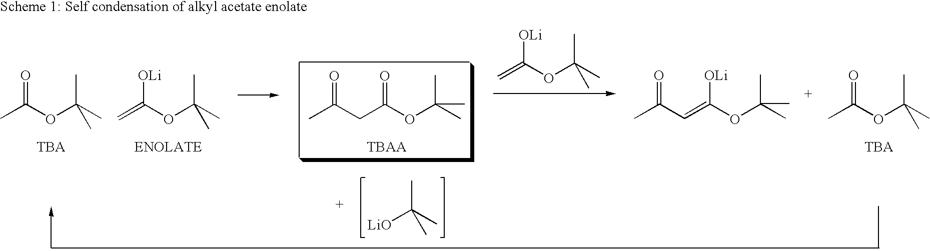

### Method:

TBA (1.05 eq) is added to lithamide slurry (1 eq). An aliquot is run-off into water and extracted with ethyl acetate and analysed by GCMS. Compounds were identified by comparison with known standards and peak area ratio recorded.
A. Lithamide purchased from Fisher™. (Aliquots tested at −40° C. and at 20° C.)
Result: no TBAA detected.
B. Lithamide purchased from Fisher™. Lithamide is suspended in 1 eq of liquid ammonia before adding TBA.
Result: no TBAA detected
C. Lithamide from Comparative Example 1.
Result: no TBAA detected
D. Lithamide from Comparative Example 1. Additional ammonia (4 eq) added prior to charging the TBA, and left for 1 hour
Result: trace amounts of TBAA detected
E. Lithamide from Example 1. Aliquot maintained at −40° C., TBA introduced and tested for presence of TBAA immediately.
Results: TBA:TBAA 2.5:1
F. Lithamide from Example 2. Aliquot maintained at −40° C., TBA introduced and tested for presence of TBAA immediately.
Results: TBA:TBAA 2.5:1

1. A process for preparing a lithium amide composition, comprising the steps of: (1) contacting lithium metal with ammonia to form lithium bronze; and (2) reacting the lithium bronze with a 1,3-diene or an arylolefin in the presence of a solvent, thereby providing a lithium amide composition; wherein the temperature is maintained at or below the boiling point of ammonia.

2. The process of claim 1, wherein the lithium metal is brought into contact with the ammonia by charging the ammonia to the lithium metal.

3. The process of claim 1, wherein the 1,3-diene or arylolefin is butadiene, isoprene, piperylene, dimethylbutadiene, hexadiene, styrene, methyl styrene, divinylbenzene, naphthalene or anthracene.

4. The process of claim 1, wherein the 1,3-diene or arylolefin is styrene, methyl styrene or divinylbenzene.

5. The process of claim 1, wherein the solvent is pentane, cyclopentane, hexane, heptane, octane, cyclohexane, toluene, xylene, cumene, ethyl benzene, tetralin, diethyl ether, tetrahydrofuran (THF), 2-methyl-THF, tetrahydropyran, diisopropyl ether, dibutyl ether, dioxan, methyl-tert-butyl ether or glycol ether.

6. The process of claim 1, wherein the lithium metal is contacted with four to five molar equivalents of anhydrous ammonia.

7. The process of claim 1, wherein the temperature of both steps is maintained between −33 and −78° C.

8. The process of claim 1, further comprising the step of removing excess ammonia by distillation at reduced pressure at a temperature between −33 and −78° C.; wherein the lithium amide composition has a molar ratio of lithium amide to ammonia greater than 1:0.5 (LiNH₂:NH₃).

9. A lithium amide composition prepared by the process of claim 1.

10. The process of claim 1, wherein the temperature of both steps is maintained between −35 and −65° C.

11. The process of claim 1, wherein the temperature of both steps is maintained at −40° C.

12. The process of claim 1, further comprising the step of removing excess ammonia by distillation at reduced pressure at a temperature between −33 and −78° C.; wherein the lithium amide composition has a molar ratio of lithium amide to ammonia greater than 1:1 (LiNH₂:NH₃).

13. The process of claim 3, wherein the solvent is pentane, cyclopentane, hexane, heptane, octane, cyclohexane, toluene, xylene, cumene, ethyl benzene, tetralin, diethyl ether, tetrahydrofuran (THF), 2-methyl-THF, tetrahydropyran, diisopropyl ether, dibutyl ether, dioxan, methyl-tert-butyl ether or glycol ether.

14. The process of claim 4, wherein the solvent is pentane, cyclopentane, hexane, heptane, octane, cyclohexane, toluene, xylene, cumene, ethyl benzene, tetralin, diethyl ether, tetrahydrofuran (THF), 2-methyl-THF, tetrahydropyran, diisopropyl ether, dibutyl ether, dioxan, methyl-tert-butyl ether or glycol ether.

15. The process of claim 3, wherein the temperature of both steps is maintained between −33 and −78° C.

16. The process of claim 4, wherein the temperature of both steps is maintained between −33 and −78° C.

17. The process of claim 13, wherein the temperature of both steps is maintained between −33 and −78° C.

18. The process of claim 14, wherein the temperature of both steps is maintained between −33 and −78° C.

19. The lithium amide composition of claim 9, wherein the lithium amide composition has a molar ratio of lithium amide to ammonia greater than 1:0.5 (LiNH₂:NH₃).

20. The lithium amide composition of claim 9, wherein the lithium amide composition has a molar ratio of lithium amide to ammonia greater than 1:1 (LiNH₂:NH₃).
